(19) United States
(12) Patent Application Publication
(10) Pub. No.: US 2014/0207579 A1
(43) Pub. Date: Jul. 24, 2014

(54) SYNDICATION OF ONLINE MESSAGE CONTENT USING SOCIAL MEDIA

(71) Applicant: salesforce.com, inc., San Francisco, CA (US)

(72) Inventor: Marcel LeBrun, San Francisco, CA (US)

(73) Assignee: salesforce.com, inc., San Francisco, CA (US)

(21) Appl. No.: 14/157,833

(22) Filed: Jan. 17, 2014

Related U.S. Application Data
(60) Provisional application No. 61/754,405, filed on Jan. 18, 2013.

(51) Int. Cl. G06Q 50/00; G06Q 30/02

(52) U.S. Cl. CPC G06Q 50/01; G06Q 30/0269
USPC 705/14.66

(57) ABSTRACT

A computer-based system and related operating method is presented here. The begins by sending a request to a user, the request identifying an action related to a social media account of the user. The method continues by receiving a confirmation for the request sent to the user, wherein the confirmation represents an authorization to take the action on behalf of the user. In response to receiving the confirmation, the system performs the action using a social handle of the user. The system can intelligently determine a distribution list for the request by identifying and analyzing a target community, along with the social media contacts of a group of users. In this regard, users having social media contacts that reach the target community are considered to be candidates for the distribution list.

### CROSS-REFERENCE TO RELATED APPLICATIONS

This application claims the benefit of U.S. provisional patent application No. 61/754,405, filed Jan. 18, 2013.

### TECHNICAL FIELD

Embodiments of the subject matter described herein relate generally to tools and techniques for enabling social marketing endeavors in an on-demand services environment.

### BACKGROUND

Any subject matter discussed herein should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed inventions.

Computer systems, the Internet, social networking applications and services, and social media concepts are well known and have become a common aspect of everyday life for many people. Companies, enterprises, agencies, and other entities may employ social media marketing in addition to (or in lieu of) traditional advertising and marketing techniques. In this context, social media marketing leverages social media websites, services, and applications in an attempt to increase the visibility of a product, service, event, or anything of interest.

One of the difficulties to running a successful social marketing campaign is finding the right target audience for the message that is to be published. Current techniques involve identifying individuals within a certain demographic group that may be interested in a product and placing marketing materials on the social media network pages of those interested individuals. Alternatively, some systems ask users to rate or “like” product pages. Using those likes, the social networking system will post ads related to those likes on the user's social media network page. Unfortunately, these are not efficient ways of targeting ads to users. First, people who like a product page are already familiar with it and are likely already purchasing the product. Second, demographics can be so broad and general that targeted marketing becomes ineffective. Hence, a need exists for better tools and techniques for marketing products to users.

Accordingly, it is desirable to have improved social media marketing techniques and methodologies. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram that illustrates the intersection of a target community and employee social contacts;

FIG. 2 is a block diagram that shows various participants in an exemplary embodiment of a social media based marketing system;

FIG. 3 is a simplified schematic representation of an exemplary computing platform suitable for use with the system shown in FIG. 2;

FIG. 4 is a flow chart that illustrates an exemplary embodiment of a social media marketing process;

FIG. 5 is a schematic representation of an Add Message interface, which may be generated and utilized during the social media marketing process;

FIG. 6 is a schematic representation of a Tasks interface, which may be generated and utilized during the social media marketing process;

FIG. 7 is a flow chart that illustrates an exemplary embodiment of a message recipient selection process; and

FIG. 8 is a schematic representation of an exemplary embodiment of a multi-tenant database system.

### DETAILED DESCRIPTION

The features disclosed herein may be implemented on many different types of systems. However, the examples herein are described with a focus on an on-demand services environment. A multi-tenant database system, such as that provided by salesforce.com, is one example of a suitable on-demand services environment.

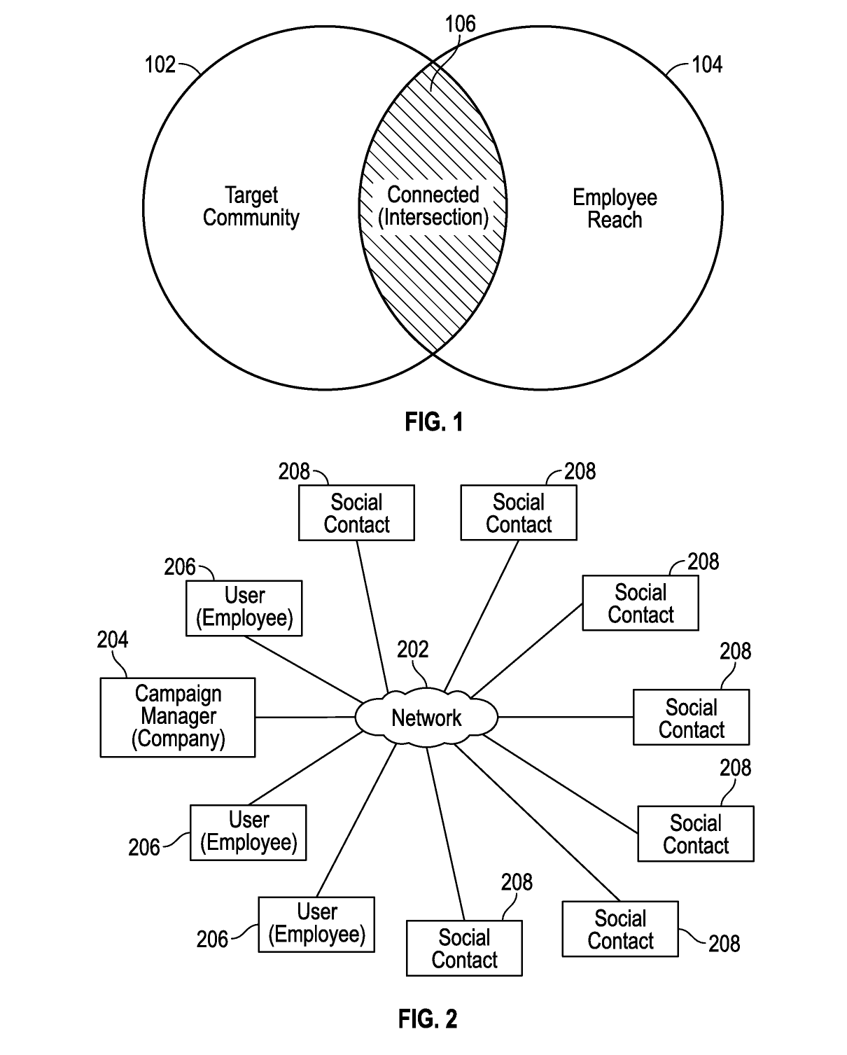

In one implementation, tools and techniques are used to recruit employees of a company to subscribe to a social marketing service and/or site. In some implementations, partners and other people may also be invited to subscribe to the service and/or site. Once users (e.g., employees, partners, etc.) have subscribed to the service and/or site, a marketing department can then find the intersection between employees' followers and the desired target community, such as influential authors in social media. In this regard, FIG. 1 is a diagram that illustrates the intersection of a target community and employee social contacts. In FIG. 1, the area 102 represents the target community, audience, or any set of designated or identified users, entities, groups, etc., the area 104 represents the total reach of the employees' social contacts, and the area 106 represents the intersection that corresponds to how connected the employees are to the desired target community.

For the examples provided here, the members of the target community may also be members of certain social media networks or services, and/or they may be passive viewers/readers of content (e.g., messages, blogs, posts, articles, etc.) published on certain social media sites or otherwise provided by social media applications or services. The target community can be defined, designated, or selected in any suitable manner. For example, the target community in one example may be people who have an interest in high-end audio equipment. As another example, the target community may be defined to be a group of people who have been identified as coffee lovers who also collect fountain pens. In practice, the target community can be defined or designated in accordance with any desired scheme or methodology.

The term “reach” may be used in this description to refer to a measure of social media contact associated with one or more users of interest. As a simple example, assume that a user has 500 designated friends on a particular social networking site and 300 followers of her blog site. The total reach for this user may be calculated as a simple sum, i.e., a total reach of 800 (regardless of whether the set of friends intersects the set of followers). Accordingly, a given user may have an extensive reach that contemplates many different social media sites, social networks, online forums, blog sites, microblog services, or the like. Referring to FIG. 1, the area 104 corresponds to the total reach of a plurality of different users, namely, a defined group of employees.

The area 106 shown in FIG. 1 indicates that there exists some common ground between the employee reach and the defined target community. In other words, there are some contacts, friends, or followers who are associated with the employees, wherein those contacts, friends, or followers are also members of the target community. The methodology described here leverages these immediate social relationships by seeking cooperation of the employees in the context of marketing campaigns, content distribution, message posting, and the like.

Accordingly, when a connected intersection is found (as depicted in FIG. 1), the marketing department (or other part of an organization) can syndicate marketing content to employees who are connected to influential people in social media sites. By doing so, the marketing content is sent to people that influence others, and targets the message to people who are influential and their followers.

In one implementation, the system manages communication with social media channels to handle scheduling and exception handling. Additionally, an embodiment of the system performs graph analysis to find existing linkages between an enterprise and its community through its employees' own personal networks.

In one implementation, the tools and techniques described here allow users to create communities and assign campaign managers to those communities. Campaign managers can associate campaigns to known communities.

In one implementation, the tools and techniques described here allow users to show target community growth rate, show employee penetration rate into target community, abstract target community from campaign coupling, create an audience and observe it over time to justify creating a campaign, generate and analyze daily trending, etc.

In certain embodiments, a social graph provides insight into how well a marketing campaign is reaching its target audience.

In accordance with an exemplary embodiment, computer-based tools, software, and systems (including existing social media monitoring or analytics systems) can provide much of the basic analytical functionality. For example, users of the social relationship marketing (SRM) system described here may be an enterprise's users, which will typically be employees of a company. People found on the web through a designated topic profile (which may be generated by the SRM in response to user-entered keywords) may represent the target community as shown in FIG. 1. In this context, social media links from the employees to the members of the target community are the connections that correspond to the intersection area 106 shown in FIG. 1.

In accordance with certain implementations, the target community is defined as a group of social media users who are influential in a designated topic, subject, or area of interest. Accordingly, the SRM system may monitor the social web/cloud and generate queries for user posts (e.g., posts generated by the TWITTER social networking service) that have been crawled in the past thirty days for the given topic profile, where the topic profile is in the set of all topic profiles that are associated with an SRM campaign. The results can be analyzed to capture the user identifiers, social handles, or usernames of the influential authors.

In accordance with certain embodiments, employee reach is associated with the social media accounts owned by the users of the enterprise. The system may be designed to fetch the follower IDs of each of the social media accounts, and store the follower IDs, keyed off the user IDs. After all followers are found, a master set for the enterprise is also stored for reference.

The SRM system described here is computer-implemented in that it may utilize at least one computer device having the desired configuration, platform, and functionality. In certain exemplary embodiments, the SRM system can be accessed and utilized by any number of users, wherein each user may use one or more computing devices to access the SRM system. In this regard, FIG. 2 is a block diagram that shows various participants in an exemplary embodiment of a social media based marketing system, e.g., an SRM. The system may include or utilize a suitably arranged network 202 that supports data communication among the various computing devices. It should be appreciated that the network 202 may utilize any number of data communication protocols and technologies (e.g., protocols and technologies related to local area networks, wireless networks, the Internet, cellular telecommunication networks, or the like). Although not always required, the network 202 provides Internet access as needed to the end user devices supported by the system, such that the system can perform the methods, tasks, and processes described in more detail herein.

FIG. 2 shows a simplified environment that supports at least one campaign manager 204 associated with an enterprise, an entity, or a company. For ease of understanding, this non-limiting example assumes that the campaign manager 204 is a person responsible for at least one social media marketing campaign on behalf of a company. Thus, FIG. 2 also depicts a number of users 206 who are employees of the company. Although only three users 206 are depicted, a practical SRM system may support any number of users 206. FIG. 2 also illustrates a number of social contacts 208. In the context of this example, the social contacts 208 represent people, entities, groups, etc., wherein the social contacts 208 may be socially connected or linked to one or more of the users 206. Although only seven social contacts 208 are shown in FIG. 2, the system could be configured to support and contemplate any number of social contacts 208.

A social contact 208 may be a person, an entity, an enterprise, a group, or anything that has a presence in the social media universe. Although not always required, a social contact 208 will typically be associated with a particular social handle, i.e., a username. A given social handle may be used in one or more social media contexts. For example, a person named John Baker Spratt could be known as the user “JBSpratt” within one social network, and as the user “John B. Spratt” within a different social network. In this scenario, the person named John Baker Spratt may be viewed as two different social contacts 208. As another example, a business entity known as Acme Hats could have a social media presence using the social handle “AcmeHats101” consistently across multiple social media services. In this scenario, the company Acme Hats could be perceived as only one social contact 208 or it could be viewed as multiple social contacts 208 (a different one for each social media service).

Notably, the sets of campaign managers 204, users 206, and social contacts 208 need not be mutually exclusive. Moreover, any one person could have multiple social “roles” within the system. For example, a person named Mark Doe may be the designated campaign manager 204 for one particular marketing campaign of the company. The same person (Mark Doe), however, may also be included in the group of users 206 if he is also an employee of the company. Furthermore, Mark Doe could be designated as a social contact 208 of one or more other users 206. For example, if Mark Doe is indeed an employee of the company, then he will probably be in the social network of other employees of the same company. Consequently, Mark Doe could be a social contact 208 of those employees.

It should also be appreciated that any of the entities depicted in FIG. 2 (i.e., the campaign manager 204, the users 206, and the social contacts 208) can interact with the system via any number of computing devices. Thus, the blocks shown in FIG. 2 need not represent physical computing devices that are assigned to the different entities. Rather, any person having valid credentials could access the system using one or more of the following, without limitation: a traditional desktop computer; a laptop computer; a tablet computer; a smartphone device; a web-enabled electronic device; a video game console having Internet connectivity; a digital media player device; a smart television set; a video services receiver; a medical device; a navigation device; home entertainment equipment; a web-enabled household appliance; or the like.

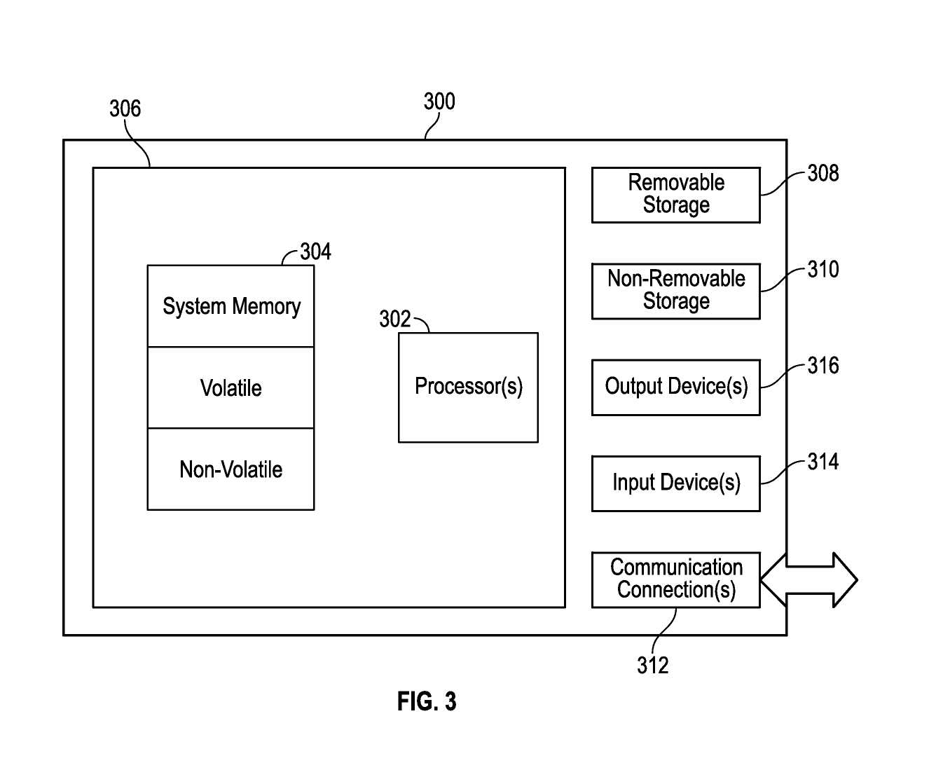

FIG. 3 is a simplified schematic representation of an exemplary computing system 300 that is suitable for use in an SRM system. In this regard, a computing device used by the campaign manager 204, a user 206, and/or a social contact 208 (see FIG. 2) may be configured in accordance with the general architecture shown in FIG. 3. Moreover, a server device that supports the backend processing described here could be generally configured as shown in FIG. 3. The computing system 300 is only one example of a suitable operating environment, and is not intended to suggest any limitation as to the scope of use or functionality of the inventive subject matter presented here. Other well-known computing systems, environments, and/or configurations that may be suitable for use with the embodiments described here include, but are not limited to, personal computers, server computers, hand-held or laptop devices, multiprocessor systems, microprocessor-based systems, network PCs, minicomputers, mainframe computers, distributed computing environments that include any of the above systems or devices, and the like.

The computing system 300 is designed and configured to process and perform computer-executable instructions, such as program modules. Generally, program modules include routines, programs, objects, components, data structures, and/or other elements that perform particular tasks or implement particular abstract data types. Typically, the functionality of the program modules may be combined or distributed as desired in various embodiments.

The computing system 300 typically includes at least some form of computer readable media. Computer readable media can be any available media that can be accessed by the computing system 300 and/or by applications executed by the computing system 300. By way of example, and not limitation, computer readable media may comprise tangible and non-transitory computer storage media. Computer storage media includes volatile, nonvolatile, removable, and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the computing system 300. Combinations of any of the above should also be included within the scope of computer readable media.

Referring again to FIG. 3, in its most basic configuration, the computing system 300 typically includes at least one processor 302 and a suitable amount of memory 304. Depending on the exact configuration and type of platform used for the computing system 300, the memory 304 may be volatile (such as RAM), non-volatile (such as ROM, flash memory, etc.) or some combination of the two. This most basic configuration is identified in FIG. 3 by reference number 306. Additionally, the computing system 300 may also have additional features/functionality. For example, the computing system 300 may also include additional storage (removable and/or non-removable) including, but not limited to, magnetic or optical disks or tape. Such additional storage is represented in FIG. 3 by the removable storage 308 and the non-removable storage 310. The memory 304, removable storage 308, and non-removable storage 310 are all examples of computer storage media as defined above.

The computing system 300 may also contain communications connection(s) 312 that allow the computing system 300 to communicate with other devices. For example, the communications connection(s) could be used to establish data communication between the computing system 300 and devices or terminals operated by developers or end users, and to establish data communication between the computing system 300 and the network 202 shown in FIG. 2. The communications connection(s) 312 may also be associated with the handling of communication media as defined above.

The computing system 300 may also include or communicate with various input device(s) 314 such as a keyboard, mouse or other pointing device, pen, voice input device, touch input device, etc. Although the exemplary embodiment described herein utilizes a mouse device, certain embodiments can be equivalently configured to support a trackball device, a joystick device, a touchpad device, or any type of pointing device. The computing system 300 may also include or communicate with various output device(s) 316 such as a display, speakers, printer, or the like. All of these devices are well known and need not be discussed at length here.

The SRM system presented here can be implemented as an on-demand network based system that is accessible by members of an enterprise, such as a company. The subject matter described here allows a representative of the enterprise to quickly and easily send “content distribution” or “social media” suggestions to its users, wherein a user who receives a suggestion/request can simply click a graphical interface button or select a link to initiate some form of action that is performed under his social handle. The SRM system will automatically track data, such as the number of users each request is sent to, the number of users who actually participated in the suggested activity, how many “clicks” were registered in response to user participation, and which users are leaders in terms of participation, social media traffic, or the like.

In accordance with certain embodiments, the SRM system generates and sends message requests to a group of users (e.g., employees of a company) with little or no consideration of the social media contacts, the social media reach, the social influence, or the subject matter interests of the group of users. Moreover, in accordance with some embodiments, the SRM system generates and sends message requests to the group of users with little to no consideration of the potential target audience. In such embodiments, the SRM system functions as an automated and efficient mechanism by which a desired message or action can be delivered to a defined group of users, wherein the goal is to simply reach as many people as possible.

In accordance with enhanced and more intelligent embodiments, the SRM system leverages “social graph” technologies to better define the group of users in a way that is designed to maximize the marketing benefits. In such embodiments, the system attempts to gain accurate knowledge of who the social contacts are, and whether or not they may be interested in the message or desired action. Moreover, the SRM system could be configured to filter or disregard users in the group having overlapping target community members as social contacts (so that those target community members are not annoyed or bothered with redundant messages or posts related to the same item).

Assume, for example, that a company is trying to market its premium brand of coffee, Awesome Acme Coffee. In practice, the company might be interested in finding coffee connoisseurs for content distribution, marketing, and advertisement. Moreover, research and statistical analysis may reveal that there are two million coffee lovers who routinely use a social media application such as the TWITTER service. With this information in mind, the SRM system determines whether any of the coffee lovers are socially linked or otherwise connected to the group of users. The system can build a social graph to determine what percentage of the users are are connected to the coffee lovers. The system could also customize the marketing message/request by identifying the target audience to the users (in an attempt to influence the manner in which the users respond to the message).

As mentioned above, the SRM system presented here can utilize social graph analysis to enhance the content syndication methodology. In practice, the SRM system can obtain or collect public content and data to glean information about the user base (e.g., the group of employees, the target community, or the like). To automate the process even further, the SRM system may ask the group of enterprise users (e.g., the employees) for permission to access some or all of their social network data. This enables the SRM system to access a user's information for a given social network platform and then publish content on her behalf, using the accessed user data. In practice, this form of authorized access can be performed through the mechanism prescribed by the social network itself (e.g., the FACEBOOK system), and is typically an authorization mechanism such as that defined by the open standard known as OAuth, whereby third party applications obtain permissions. Typically, the user can grant/remove permissions at any time from within the particular social network platform itself.

Accordingly, the SRM system may be configured to autonomously access the users' contacts lists and/or perform authorized actions on behalf of the users. For example, the SRM system may invite a user to create a post on her FACEBOOK social network profile page and, in response to a confirmation from the user, automatically access the user's login name (or user ID) and the user's authentication tokens for the FACEBOOK social network system, such that the SRM system can generate the desired post on behalf of that user. Thus, if the user gives the SRM the necessary permissions, the system can actually publish content on behalf of the user, with no further user involvement. The target audience will view the published content, post, or article as usual, i.e., as if the content were distributed by the user herself.

In accordance with the exemplary embodiments described here, the SRM system cooperates with and leverages one or more social accounts, e.g., user accounts for various applications related to social networking, social media, online forums, content publication or distribution, or the like. For ease of reference, these and other similar applications and services may be considered to fall under the general label of “social media” applications. In practice, the SRM system could include, cooperate with, or otherwise reference any of the following popular social media applications, without limitation: the FACEBOOK social networking application; the TWITTER social networking application; the LINKEDIN social networking application; the INSTAGRAM photo sharing application; the PINTEREST content sharing application; the LAST.FM online music application; the YOUTUBE video sharing application; and the like. It should be appreciated that the SRM system and the content syndication methodologies described here need not be limited to traditional social media applications and accounts, and that the concepts presented in more detail below can be equivalently applied to other application platforms if so desired.

In practice, a system administrator may be responsible for maintaining a list of users, along with the social media user accounts that are leveraged by the SRM system. In this context, the SRM system allows an administrator to manage user contact lists; add, edit, or delete users; add add social media user accounts; delete accounts; edit or modify details of accounts; etc. For example, the SRM system may allow an administrator to upload any number of users, and to categorize users according to their roles, duties, or responsibilities. In this regard, the SRM system may support administrator users, campaign managers, end users, or the like. Moreover, a particular user of the SRM system may have a given set of permissions that are dictated by his or her login credentials. As another example, the SRM system could maintain a list of different FACEBOOK user accounts, a list of TWITTER user accounts, and a list of INSTAGRAM user accounts. In a typical implementation, each user account listed for a given social media application will be associated with a respective social handle. Moreover, the SRM system may store or gain access to corresponding account information for each user account as needed. For example, the respective login credentials, contact information (phone number, email address, real name, etc.), and/or other information could be stored or accessed in association with each user account.

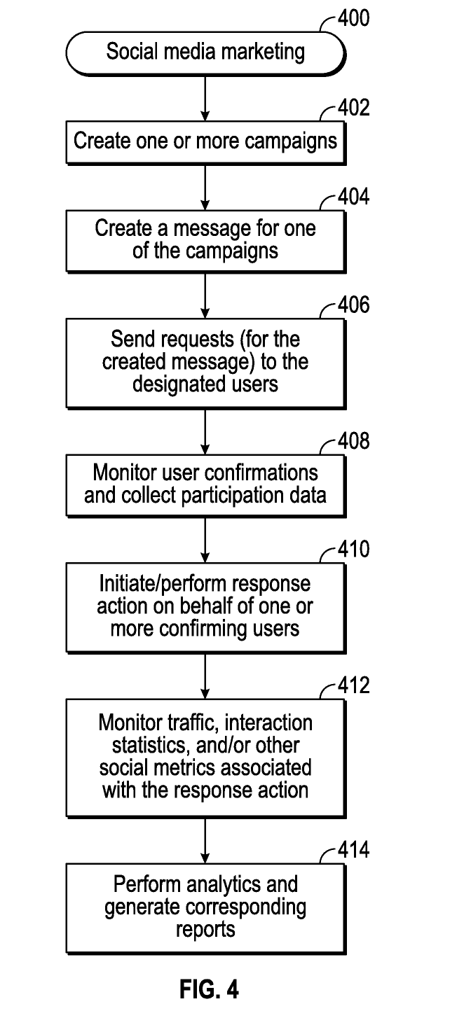

The following description assumes that a host SRM system has already been suitably configured to support the intelligent syndication of social media content. Accordingly, the following description assumes that the SRM system has already been provided with an appropriate list of users and with an appropriate list of social media accounts. FIG. 4 is a flow chart that illustrates an exemplary embodiment of a social media marketing process 400, which may be performed by the SRM system. The various tasks performed in connection with a process described herein may be performed by software, hardware, firmware, or any combination thereof. It should be appreciated that a described process may include any number of additional or alternative tasks, that the tasks shown in the figures need not be performed in the illustrated order, and that a described process may be incorporated into a more comprehensive procedure or process having additional functionality not described in detail herein. Moreover, one or more of the tasks shown in the figures could be omitted from an embodiment of the illustrated process as long as the intended overall functionality remains intact.

Referring to FIG. 4, the social media marketing process 400 may begin with the creation of one or more marketing campaigns (task 402). A campaign could be created by any user having the appropriate permissions, e.g., an administrator, a campaign manager, a director, or the like. Creating a campaign is desirable to allow users, such as campaign managers, to organize related social content and messages in a common place. In certain embodiments, task 402 allows a user to: enter a name for a new campaign; associate a topic profile, category, or description to the campaign; designate an open date and a close data (if any) to the campaign; select the managed social media accounts for the campaign; identify the campaign managers for the campaign; and/or select the end users that are permitted to access the campaign. Of course, other information and options could be designated during the creation of a new campaign; the examples provided here are not intended to be limiting or exhaustive.

After one or more campaigns have been created, the process 400 may create a message for one of the active campaigns (task 404). In practice, the SRM system generates and presents an appropriately formatted graphical user interface (GUI) to the user, such that the user can enter information, select options, save the message as a draft, or publish the message. Task 404 may allow the user to perform any of all of the following actions: enter a title or a name for the message; associate the message with one of the active campaigns; schedule a publication date/time for the message (i.e., designate when the message will be sent to the designated end users); schedule an end date/time for the message (i.e., designate when the message will no longer be visible by the end users, or when the message will be removed from the to-do lists or task lists of the end users); select the recipients of the message; input the content or body of the message; enter or paste links or URLs into the message; designate attachments for the message (e.g., images, documents, video clips, or other files); or the like.

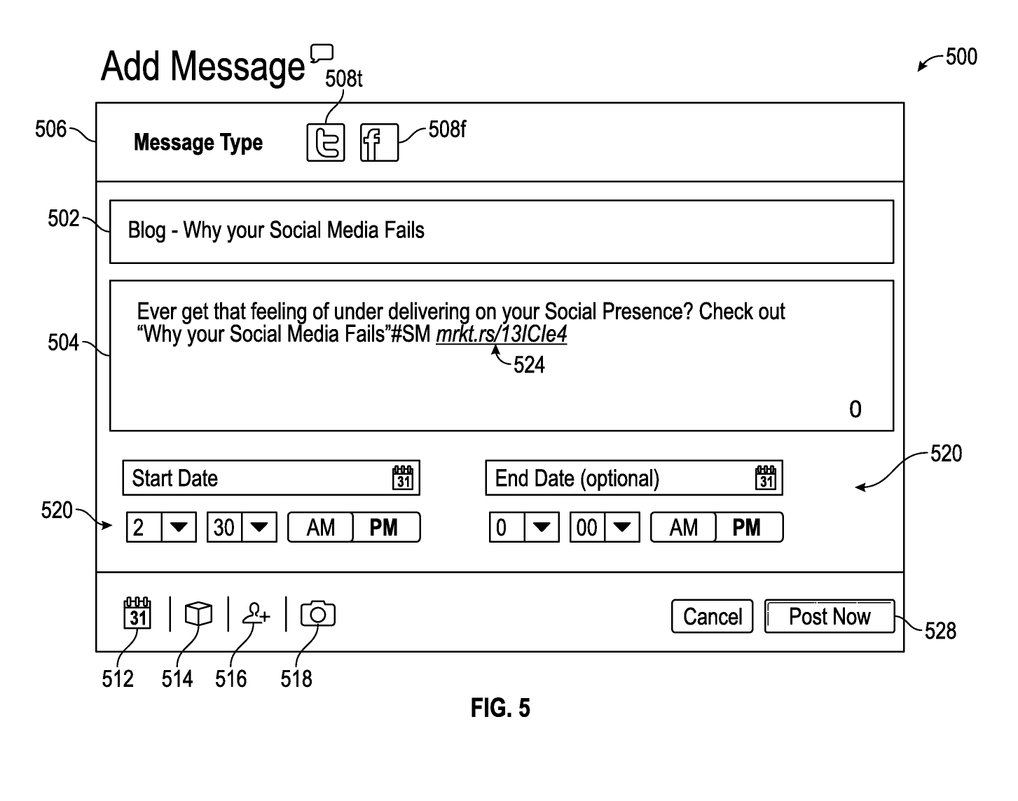

FIG. 5 is a schematic representation of an Add Message interface 500, which may be generated and utilized during the social media marketing process 400. This exemplary rendition of the Add Message interface 500 includes a message name field 502 that accommodates entry of the message name or title, and a message body field 504 that accommodates entry of the message content. The illustrated version of the Add Message interface 500 also includes a message type region 506 that allows the user to select one or more social media platforms for purposes of distribution or publication of the created message. The message type region 506 may include selectable icons 508 that represent the available social media platforms. The illustrated example includes one icon 508t that can be activated to select the TWITTER social network as a destination, and another icon 508f that can be activated to select the FACEBOOK social network as a destination. It should be appreciated that the Add Message interface 500 could display more or less than two icons 508, depending on the number of supported social media accounts and/or the particular SRM system configuration settings.

In certain embodiments, the functional characteristics of the message body field 504 are influenced by the selected icons 508. In this regard, the functionality of the message body field 504 may be dictated by the capabilities of the selected social media platforms. For example, if the user selects the icon 508t (which designates the TWITTER social network), then the message body field 504 is automatically configured such that only a limited number of characters can be entered. Currently, the TWITTER social network only supports SMS messages having at most 140 characters. Accordingly, if the icon 508t is selected, the message body field 504 will be limited to only 140 characters, regardless of whether the icon 508f (for the FACEBOOK social network) is also selected. In contrast, if only the icon 508f is selected, then the message body field 504 need not be restricted to only 140 characters. As another example, if a selected social media platform does not support the use of embedded hyperlinks, then the message body field 504 can be configured such that URLs and other links appear as plain text. Other restrictions, limitations, and functional compatibility features may also be influenced by the selected icons 508. Moreover, characteristics of the message name field 502 may also be influenced by the selected icons 508.

The depicted embodiment of the Add Message interface 500 includes the following selectable icons, without limitation: a calendar icon 512; a campaign icon 514; a contacts icon 516; and an image icon 518. Selection of the calendar icon 512 causes a schedule field 520 to be displayed (or to become active). The schedule field 520 allows the user to designate the start date for publication of the message and, if desired, the end date of the message, as described above. Selection of the campaign icon 514 allows the user to indicate a marketing campaign for the message, and selection of the contacts icon 516 allows the user to select the recipients of the message. In practice, selection of the contacts icon 516 may cause the system to generate and display an interactive contacts list, a matrix or grid of user images/avatars, a directory, or the like. This enables the user to select and designate one or more users as the recipients of the message being created. The image icon 518 allows the user to upload or otherwise attach a picture to the message such that the attached picture is sent to the identified recipients. Although not shown in FIG. 5, the Add Message interface 500 may include additional control elements and/or interactive icons, such as an attachment icon that enables the user to upload or otherwise attach files (other than image files) to the new message.

This example assumes that the message includes content that is intended for publication. As shown in FIG. 5, the message to be published by the end users is provided in the message body field 504. Although not always required, the message to be published also includes a link 524 to an online resource, which will typically be a web page. In certain embodiments, the link 524 may be uniquely encoded for each end user (even though the link 524 points to the same online resource). This allows the SRM system to monitor traffic associated with the link 524, e.g., the number of clicks that can be traced back to each individual end user.

This example also assumes that the message creator has designated one or more users as recipients of the created message (using, for example, the contacts icon 516). Upon completion of the message, the creator can select a “Post Now” icon 528 to initiate the delivery of the message to the designated users. In this regard, the social media marketing process 400 may continue by generating and sending corresponding requests to each of the designated users (task 406—see FIG. 4). In this context, a request identifies an action related to at least one social media account of the recipient. In certain embodiments, each request relates to only one social media account of a user; if the created message is intended for a plurality of different social media accounts of a user, then a respective plurality of requests are sent to that particular user. Thus, the user will receive multiple requests—one for each social media account. In alternative implementations, a single request could be issued regardless of the number of social media accounts identified during message creation.

The desired action (or actions) contained in a request will be dictated by the message type. For the example shown in FIG. 5, the request may be considered to be a content distribution or publication request because the action to be performed relates to the posting of the message content and the link 524 to the end user's FACEBOOK account and/or to the end user's TWITTER account. In this regard, a content distribution request may identify an action that results in the distribution of a message that is intended for the target community, e.g., posting the message content on a social networking site, sending a Short Message Service (SMS) item that conveys the message, sending an email, or the like. As another example, the request may identify previously published content (using a referring link and/or by including at least some of the previously published content), and the identified action may be associated with re-publishing the previously published content. As yet another example, the request may identify a target, which may be an individual user, an entity having a social presence, a business or an enterprise, a group of users, or the like. For such requests, the desired action may be associated with creating a social connection or link between the identified target and the end user who receives the message. In certain contexts, this type of action may relate to “following” or “liking” or “friending” the identified target.

After creating and posting a message, the campaign manager (and/or other authorized personnel) can view a list of active messages, which may be sorted or organized in any desirable manner. The campaign manager can edit, delete, pause, resume, or reschedule posted messages using a suitably formatted user interface.

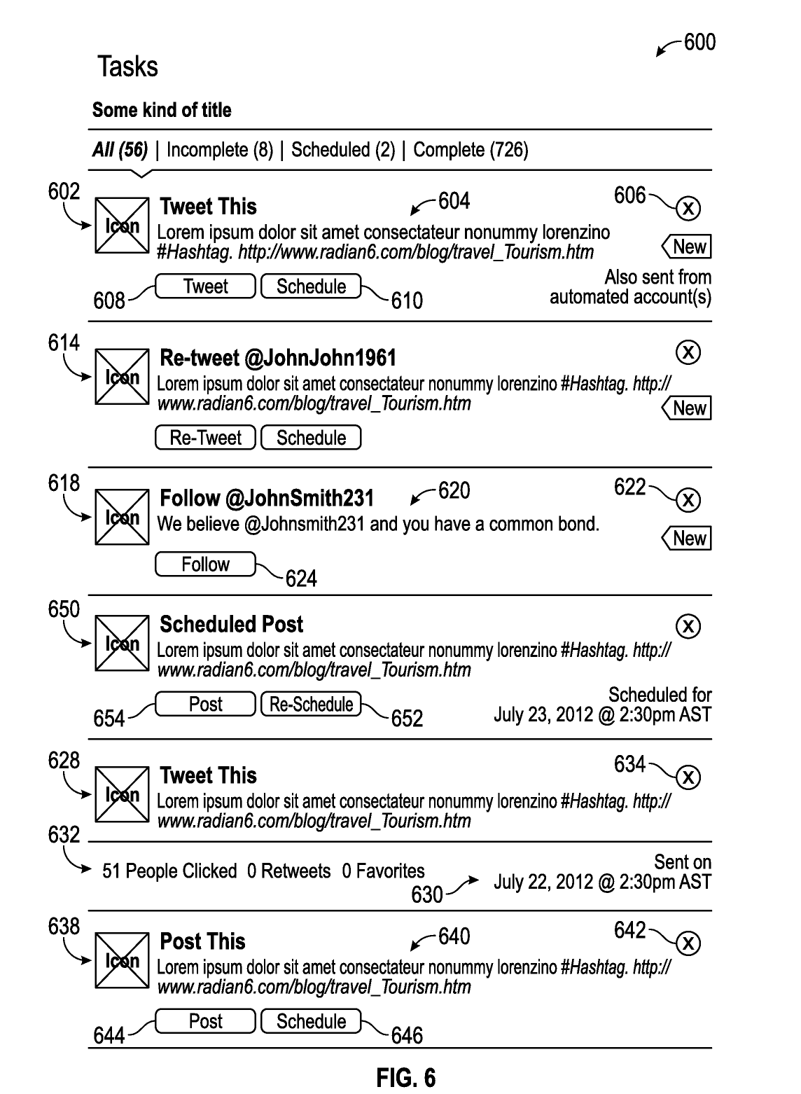

This description assumes that the designated end users receive the respective requests, and that the end users are able to view and respond to each request in an appropriate manner. In this regard, FIG. 6 is a schematic representation of a Tasks interface 600, which may be generated and utilized during the social media marketing process 400. A suitably formatted and populated Tasks interface 600 can be presented to each end user of the SRM system in an on-demand manner. The Tasks interface 600 is user-specific in that it contains a list of tasks (i.e., requests, messages, action items, etc.) assigned to or otherwise intended for the particular user. This exemplary version of the Tasks interface 600 includes the following selectable categories, without limitation: All; Incomplete; Scheduled; and Complete. FIG. 6 depicts the Tasks interface 600 in a state where the All category is currently selected.

For the illustrated example, the user has three new requests that have been recently posted. A first request 602 corresponds to a request to tweet a message containing a link (i.e., create a message for publication using the TWITTER social media platform). The title of the first request 602 is “Tweet This”, and the desired content to be distributed appears in a content field 604. The first request 602 appears with a number of GUI items that allow the user to perform various actions related to the first request 602. For example, the Tasks interface 600 includes a remove button 606 that allows the user to delete the first request 602 from the list. The first request 602 also includes a Tweet button 608 that allows the user to confirm participation and initiate an action that will result in the creation and publication of the corresponding tweet. Although not always required, the illustrated embodiment also includes a Schedule button 610 that allows the user to schedule the creation and publication of the tweet at some time in the future. A second request 614 corresponds to a request to re-tweet a message containing a link. The general characteristics and features of the second request 614 are similar to those described above for the first request 602.

A third request 618 corresponds to a request to follow a target user who is known by the social handle JohnSmith231. The title of the third request 618 is “Follow @JohnSmith231”, and the request includes a comment that appears in a comment field 620. Note that the content of the comment field 620 need not be published or distributed. Rather, the comment field 620 is used to inform the user and to provide instructions if so desired. The third request 618 appears with a remove button 622 that allows the user to delete the third request 618 from the list. The third request 618 also includes a Follow button 624 that allows the user to confirm participation and initiate an action that results in the user following JohnSmith231.

The Tasks interface 600 also includes three old or existing items. An entry 628 corresponds to a completed request to tweet a message containing a link. The entry 628 includes a time/date stamp 630 that indicates when the tweet was sent. Notably, the entry 628 may also include a statistics field 632 that summarizes activity associated with the user's tweet. For this example, the statistics field 632 indicates the number of people that clicked on the link contained in the message, the number of re-tweets of the message, and the number of people who designated the message as a favorite. In alternative embodiments, the statistics field 632 may include additional and/or alternative data if so desired. The entry 628 may be rendered with a remove button 634 that allows the user to delete the entry 628 from the list.

The Tasks interface 600 also includes a request 638 that corresponds to a pending request to post a message containing a link (e.g., post the suggested message on the user's profile page as maintained by a designated social networking site, post the suggested message on an online discussion forum, or the like). The title of the request 638 is “Post This”, and the desired content to be distributed appears in a content field 640. The request 638 appears with a number of GUI items that allow the user to perform various actions related to the request 638. For example, the request 638 is rendered with a a remove button 642 that allows the user to delete the request 638 from the list. The request 638 also includes a Post button 644 that allows the user to confirm participation and initiate an action that will result in the creation and posting of the message that appears in the content field 640. Although not always required, the illustrated embodiment also includes a Schedule button 646 that allows the user to schedule the creation and posting of the message at some time in the future. In this regard, FIG. 6 depicts an entry 650 that corresponds to a post that has been scheduled. The entry 650 includes a Re-Schedule button 652 that enables the user to change the scheduled posting date/time if so desired. The entry 650 also includes a Post button 654 that allows the user to override the schedule and immediately post the message.

It should be appreciated that the format, content, and exemplary items shown in FIG. 6 are not intended to be limiting or exhaustive, and that the SRM system described here could be designed to accommodate any number of different request types. The GUI elements rendered in association with each request can vary from one embodiment to another, and the specific content may vary depending on the current status of the requests.

Referring back to FIG. 4, the social media marketing process 400 monitors end user activities related to the issued requests and collects relevant participation data in an ongoing manner (task 408). For example, the process 400 may receive confirmations when the end users initiate the actions identified in the requests, when the end users schedule an action, when the end users delete requests, or the like. In certain embodiments, a confirmation may include, convey, or otherwise represent an authorization to take the designated action on behalf of an end user. Additional participation data can be collected and analyzed to generate statistics and metrics related to individual requests and messages, campaigns, or the like. For example, the SRM system may collect data associated with user participation in a content distribution request, generate participation statistics from the collected data, and provide the participation statistics to the group of users. The participation statistics could be utilized to add a gaming or competition aspect to the SRM system, such that the end users can view the participation statistics, social standing, social media reach, and other information related to the users' activities. For example, the SRM system could maintain and generate a leaderboard that indicates the most active end users from a participation and/or social standing standpoint, as a means of motivating less active users to contribute more.

This example assumes that at least one end user has responded to a request (sent at task 406; see FIG. 4). More specifically, this example assumes that an end user has confirmed her participation by initiating a command to tweet a message, post some content, create a social link to a target user, send a text message, send an email, etc. In accordance with one exemplary approach, the SRM system merely issues requests and monitors the corresponding end user activity. For such an approach, the SRM system does not automatically initiate or perform the desired action on behalf of the user. Rather, the system relies on the end users to follow up with the desired action items. In accordance with the illustrated embodiment, however, the social media marketing process 400 initiates and performs the desired response action on behalf of one or more confirming users (task 410). As explained above, the SRM system can be given the permission to access the users' login IDs and authentication tokens as needed to perform the designated actions using the social handles of the end users.

As mentioned above, the type of action that is automatically performed during task 410 will be dictated by the associated message request. Thus, if the confirmed request includes a message intended for publication, performing the action may involve posting the message on a social networking site, such as FACEBOOK. As another example, the action may involve sending an SMS item that conveys a message. In this regard, the process 400 may send a text message or a tweet on behalf of a responding user. As another example, if the confirmed request identifies previously published content, then performing the action may involve re-publishing the identified content (e.g., re-posting an article, re-publishing a link to an online resource, or re-tweeting a message). In accordance with yet another example, the confirmed request identifies a target user, group, or entity. A confirmed request of this type may initiate an action that creates a social connection or link between the responding user and the identified target. Thus, if the target is a user of a social media application (such as TWITTER), then creating the social connection may result in the responding user following the target user. It should be appreciated that other scenarios and action types are contemplated, and that a request confirmation may represent an authorization to take any desired action on behalf of the confirming user.

As explained above with reference to FIG. 5 and FIG. 6, the messages and content handled by the SRM system may include links to online resources, such as web pages. The SRM system can generate the links in an encoded manner such that the system can monitor and analyze traffic, interaction statistics, and/or other social metrics associated with the response activities and designated actions (task 412). For example, if a request includes a link to a particular online resource, and the request is delivered to five different end users, then each of the five users may receive a user-specific link that has been encoded in a way that allows the SRM system to correlate subsequent interaction with the user-specific links to the respective end users. Accordingly, the SRM system can collect traffic statistics related to the number of clicks associated with each of the five links, and analyze the individual user statistics if so desired.

The process 400 may continue by performing analytics and generating corresponding reports, graphs, lists, charts, or the like (task 414). In accordance with some embodiments, an analytics summary is generated to provide an administrator or a campaign manager with a high level summary of the information handled by the SRM system. Additionally (or alternatively), message-centric analytics are also provided. In this regard, statistics and metrics related to a group of messages and/or individual messages can be generated and displayed to a campaign manager. Additionally (or alternatively), campaign-centric analytics are also provided. Thus, statistics and data related to all of the active campaigns and/or individual campaigns can be generated and displayed as needed. The analytics data may include any or all of the following information, without limitation: a total number of messages created by a campaign manager; a listing of message requests (or campaigns) that have received a high amount of end user participation; a listing of messages, links, or campaigns that have received a high amount of online interaction (clicks); a listing of messages or campaigns that have the highest social reach; and a listing of top end user contributors.

Referring back to FIG. 4, the social media marketing process 400 sends each message requests to one or more designated end users. In accordance with one approach, the recipients are manually selected (individually, by group, by distribution list, etc.) by the campaign manager or by the person creating the message request with little to no consideration given to the social reach of the end users, and with little to no consideration given to the subject matter interests of the end users. In accordance with such an approach, the SRM system simply broadcasts the message request to the recipients under the assumption that the recipients will take the action necessary to increase the distribution, publication, and digestion of the desired content.

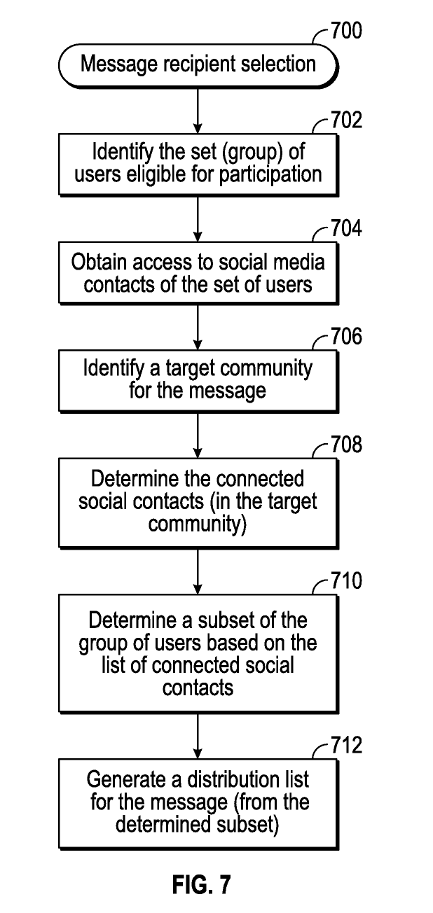

In accordance with certain enhanced implementations, the SRM system employs social graphing techniques and methodologies to intelligently identify the message recipients. In this regard, FIG. 7 is a flow chart that illustrates an exemplary embodiment of a message recipient selection process 700, which may be performed by the SRM system as a component of the social media marketing process 400. The illustrated embodiment of the process 700 may begin by identifying the set or group of end users eligible for participation in the message request to be created (task 702). In this regard, the eligible group of users may be considered to be a relatively general and non-specific set of users, e.g., all the employees of a company. Sending a message request to the entire population of users supported by the SRM system may not be practical, efficient, or effective from a results standpoint. Accordingly, the process 700 attempts to intelligently identify a subset of those users, wherein the subset of users are more likely to be interested in the subject matter of the message and/or are more likely to have strong social contacts to the desired target community.

In certain implementations, the process 700 obtains access to the social media contacts of the group of eligible users (task 704) and/or obtains access to the social media data, accounts, or information for the group of eligible users. The process 700 also identifies or obtains a target community for the message (task 706). As mentioned above, the target community represents the marketing target for the given campaign, the particular message, or the like. In practice, the target community may be manually designated or identified by the campaign manager or the person creating the message request, or it could be automatically identified based on keywords, seed phrases, categories, topics, or subjects entered by a user.

The process 700 may continue by analyzing the social media contacts of the group of users, social data corresponding to the group of users, social data corresponding to the target community, and possibly other information if available to determine which social contacts are also found in the target community (task 708). In other words, the social reach of the group of users is compared against the target community to determine the connected social contacts (see, for example, the intersecting area 106 shown in FIG. 1). The SRM system assumes that communicating the message to the connected social contacts will bear more fruit than randomly communicating the message to all of the social contacts associated with the overall group of users.

Next, the process 700 determines a subset of the eligible group of users based on the list of connected social contacts (task 710). Each member of the subset of users has a social relationship with at least one of the connected social contacts. Notably, the SRM system may include a filtering of selection methodology to eliminate redundancy associated with “overlapping” connected social contacts. For example, if one member of the target community is socially connected to three different end users, then the SRM system may choose only one of the three connected users as a recipient of the message request. In practice, the SRM system could make an intelligent decision based on the social reach of the connected users, historical participation data, a measure of social influence of the connected users, etc. It should be appreciated that such filtering of redundant users is optional—the process 700 need not eliminate any of the connected social contacts.

The process 700 continues by generating a distribution list for the message request, wherein the distribution list is generated from the subset of connected users (task 712). In most typical scenarios, the distribution list will include each and every member of the subset. In certain situations, however, there may be reasons to exclude one or more members of the subset. The distribution list identifies the intended recipients of the message request. In this context, task 406 (see FIG. 4) would send the requests to the end users found on the distribution list.

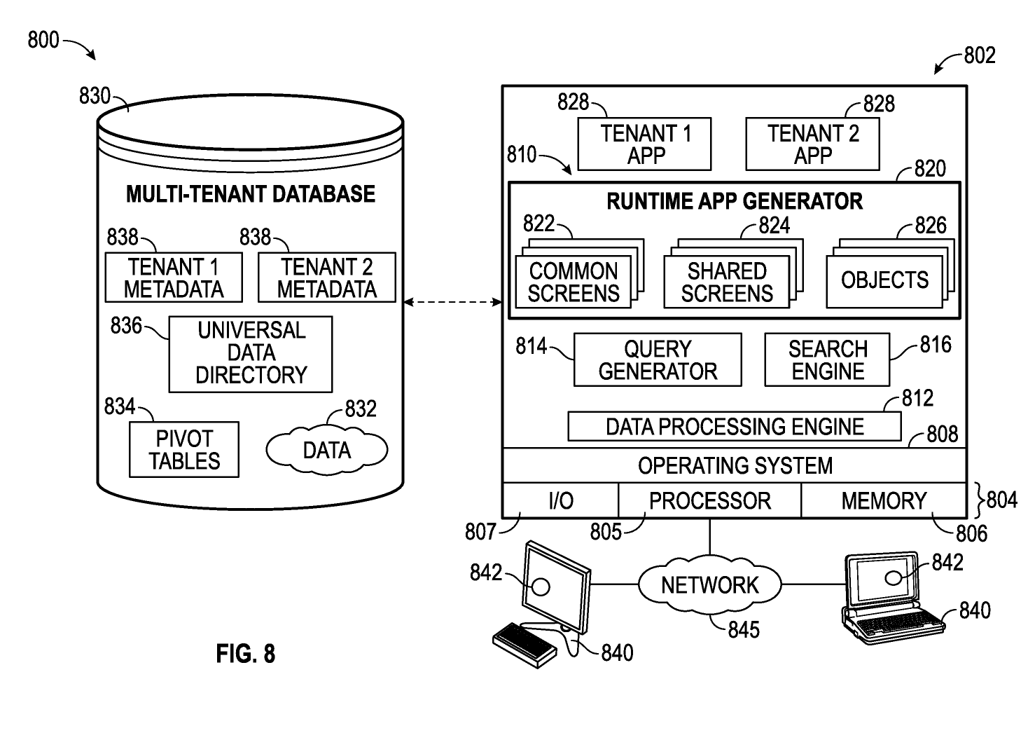

The exemplary embodiments presented here relate to various computer-implemented and computer-executed techniques related to social media systems and techniques for managing and syndicating marketing content using social media. The described subject matter could be implemented in connection with any suitable computer-based architecture, system, network, or environment, such as two or more user devices that communicate via a data communication network. Although the subject matter presented here could be utilized in connection with any type of computing environment, certain exemplary embodiments can be implemented in conjunction with a multi-tenant database environment, such as the system 800 shown in FIG. 8.

In this regard, an exemplary embodiment of a multi-tenant database system 800 is shown in FIG. 8. The system 800 suitably includes a server 802 that dynamically creates virtual applications 828 based upon data 832 from a common database 830 that is shared between multiple tenants. Data and services generated by the virtual applications 828 are provided via a network 845 to any number of user devices 840, as desired. Each virtual application 828 is suitably generated at run-time using a common application platform 810 that securely provides access to the data 832 in the database 830 for each of the various tenants subscribing to the system 800. In accordance with one non-limiting example, the system 800 may be implemented in the form of a multi-tenant customer relationship management system that can support any number of authenticated users of multiple tenants.

A “tenant” or an “organization” generally refers to a group of users that shares access to common data within the database 830. Tenants may represent customers, customer departments, business or legal organizations, and/or any other entities that maintain data for particular sets of users within the system 800. Although multiple tenants may share access to the server 802 and the database 830, the particular data and services provided from the server 802 to each tenant can be securely isolated from those provided to other tenants. The multi-tenant architecture therefore allows different sets of users to share functionality without necessarily sharing any of the data 832.

The database 830 is any sort of repository or other data storage system capable of storing and managing the data 832 associated with any number of tenants. The database 830 may be implemented using any type of conventional database server hardware. In various embodiments, the database 830 shares processing hardware 804 with the server 802. In other embodiments, the database 830 is implemented using separate physical and/or virtual database server hardware that communicates with the server 802 to perform the various functions described herein.

The data 832 may be organized and formatted in any manner to support the application platform 810. In various embodiments, the data 832 is suitably organized into a relatively small number of large data tables to maintain a semi-amorphous “heap”-type format. The data 832 can then be organized as needed for a particular virtual application 828. In various embodiments, conventional data relationships are established using any number of pivot tables 834 that establish indexing, uniqueness, relationships between entities, and/or other aspects of conventional database organization as desired.

Further data manipulation and report formatting is generally performed at run-time using a variety of metadata constructs. Metadata within a universal data directory (UDD) 836, for example, can be used to describe any number of forms, reports, workflows, user access privileges, business logic and other constructs that are common to multiple tenants. Tenant-specific formatting, functions and other constructs may be maintained as tenant-specific metadata 838 for each tenant, as desired. Rather than forcing the data 832 into an inflexible global structure that is common to all tenants and applications, the database 830 is organized to be relatively amorphous, with the pivot tables 834 and the metadata 838 providing additional structure on an as-needed basis. To that end, the application platform 810 suitably uses the pivot tables 834 and/or the metadata 838 to generate “virtual” components of the virtual applications 828 to logically obtain, process, and present the relatively amorphous data 832 from the database 830.

The server 802 is implemented using one or more actual and/or virtual computing systems that collectively provide the dynamic application platform 810 for generating the virtual applications 828. The server 802 operates with any sort of conventional processing hardware 804, such as a processor 805, memory 806, input/output features 807 and the like. The processor 805 may be implemented using one or more of microprocessors, microcontrollers, processing cores and/or other computing resources spread across any number of distributed or integrated systems, including any number of “cloud-based” or other virtual systems. The memory 806 represents any non-transitory short or long term storage capable of storing programming instructions for execution on the processor 805, including any sort of random access memory (RAM), read only memory (ROM), flash memory, magnetic or optical mass storage, and/or the like. The server 802 typically includes or cooperates with some type of computer-readable media, where a tangible computer-readable medium has computer-executable instructions stored thereon. The computer-executable instructions, when read and executed by the server 802, cause the server 802 to perform certain tasks, operations, functions, and processes described in more detail herein. In this regard, the memory 806 may represent one suitable implementation of such computer-readable media. Notably, the processor 805 and the memory 806 may be suitably configured to carry out the various tasks, functions, and methods described herein in connection with the SRM system.

The input/output features 807 represent conventional interfaces to networks (e.g., to the network 845, or any other local area, wide area or other network), mass storage, display devices, data entry devices and/or the like. In a typical embodiment, the application platform 810 gains access to processing resources, communications interfaces and other features of the processing hardware 804 using any sort of conventional or proprietary operating system 808. As noted above, the server 802 may be implemented using a cluster of actual and/or virtual servers operating in conjunction with each other, typically in association with conventional network communications, cluster management, load balancing and other features as appropriate.

The application platform 810 is any sort of software application or other data processing engine that generates the virtual applications 828 that provide data and/or services to the user devices 840. The virtual applications 828 are typically generated at run-time in response to queries received from the user devices 840. For the illustrated embodiment, the application platform 810 includes a bulk data processing engine 812, a query generator 814, a search engine 816 that provides text indexing and other search functionality, and a runtime application generator 820. Each of these features may be implemented as a separate process or other module, and many equivalent embodiments could include different and/or additional features, components or other modules as desired.

The runtime application generator 820 dynamically builds and executes the virtual applications 828 in response to specific requests received from the user (client) devices 840. The virtual applications 828 created by tenants are typically constructed in accordance with the tenant-specific metadata 838, which describes the particular tables, reports, interfaces and/or other features of the particular application. In various embodiments, each virtual application 828 generates dynamic web content (including GUIs, detail views, secondary or sidebar views, and the like) that can be served to a browser or other client program 842 associated with its user device 840, as appropriate.

The runtime application generator 820 suitably interacts with the query generator 814 to efficiently obtain multi-tenant data 832 from the database 830 as needed. In a typical embodiment, the query generator 814 considers the identity of the user requesting a particular function, and then builds and executes queries to the database 830 using system-wide metadata 836, tenant specific metadata 838, pivot tables 834, and/or any other available resources. The query generator 814 in this example therefore maintains security of the common database 830 by ensuring that queries are consistent with access privileges granted to the user that initiated the request.

The data processing engine 812 performs bulk processing operations on the data 832 such as uploads or downloads, updates, online transaction processing, and/or the like. In many embodiments, less urgent bulk processing of the data 832 can be scheduled to occur as processing resources become available, thereby giving priority to more urgent data processing by the query generator 814, the search engine 816, the virtual applications 828, etc. In certain embodiments, the data processing engine 812 and the processor 805 cooperate in an appropriate manner to perform and manage various techniques, processes, and methods described above.

In operation, developers use the application platform 810 to create data-driven virtual applications 828 for the tenants that they support. Such virtual applications 828 may make use of interface features such as tenant-specific screens 824, universal screens 822 or the like. Any number of tenant-specific and/or universal objects 826 may also be available for integration into tenant-developed virtual applications 828. The data 832 associated with each virtual application 828 is provided to the database 830, as appropriate, and stored until it is requested or is otherwise needed, along with the metadata 838 that describes the particular features (e.g., reports, tables, functions, etc.) of that particular tenant-specific virtual application 828. For example, a virtual application 828 may include a number of objects 826 accessible to a tenant, wherein for each object 826 accessible to the tenant, information pertaining to its object type along with values for various fields associated with that respective object type are maintained as metadata 838 in the database 830. In this regard, the object type defines the structure (e.g., the formatting, functions and other constructs) of each respective object 826 and the various fields associated therewith. In an exemplary embodiment, each object type includes one or more fields for indicating the relationship of a respective object of that object type to one or more objects of a different object type (e.g., master-detail, lookup relationships, or the like).

In exemplary embodiments, the application platform 810, the data processing engine 812, the query generator 814, and the processor 805 cooperate in an appropriate manner to process data associated with a hosted virtual application 828 (such as a customer relationship management application), generate and provide suitable GUIs (such as web pages) for presenting data on client devices 840, and perform additional techniques, processes, and methods to support the features and functions for the hosted virtual application 828.

Still referring to FIG. 8, the data and services provided by the server 802 can be retrieved using any sort of personal computer, mobile telephone, portable device, tablet computer, or other network-enabled user device 840 that communicates via the network 845. Typically, the user operates a conventional browser or other client program 842 to contact the server 802 via the network 845 using, for example, the hypertext transport protocol (HTTP) or the like. The user typically authenticates his or her identity to the server 802 to obtain a session identifier (“SessionID”) that identifies the user in subsequent communications with the server 802. When the identified user requests access to a virtual application 828, the runtime application generator 820 suitably creates the application at run time based upon the metadata 838, as appropriate. The query generator 814 suitably obtains the requested data 832 from the database 830 as needed to populate the tables, reports or other features of the particular virtual application 828. As noted above, the virtual application 828 may contain Java, ActiveX, or other content that can be presented using conventional client software running on the user device 840; other embodiments may simply provide dynamic web or other content that can be presented and viewed by the user, as desired.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a tangible, non-transitory, processor-readable medium in certain embodiments. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, or the like.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-implemented method comprising:
sending a request to a user, the request identifying an action related to a social media account of the user;
receiving a confirmation for the request sent to the user, the confirmation representing an authorization to take the action on behalf of the user; and
in response to receiving the confirmation, performing the action using a social handle of the user.

2. The computer-implemented method of claim 1, wherein:
the request comprises a message intended for publication; and
performing the action comprises posting the message on a social networking site.

3. The computer-implemented method of claim 1, wherein:
the request comprises a message intended for publication; and
performing the action comprises sending a Short Message Service (SMS) item that conveys the message.

4. The computer-implemented method of claim 1, wherein:
the request identifies previously published content; and
performing the action comprises re-publishing the previously published content.

5. The computer-implemented method of claim 1, wherein:
the request identifies a target; and
performing the action comprises creating a social connection between the user and the target.

6. The computer-implemented method of claim 5, wherein:
the target is a target user of a social media application; and
creating the social connection results in the user following the target user.

7. The computer-implemented method of claim 1, wherein:
the request comprises a message intended for publication;
the message comprises a link to an online resource;
performing the action comprises publishing the message; and
the method further comprises analyzing traffic associated with user interaction with the link to the online resource.

8. A computer-implemented method comprising:
identifying a target community;
analyzing social media contacts of a group of users to determine which of the social media contacts are also members of the target community, wherein the social media contacts who are also members of the target community represent connected social contacts;
determining a subset of the group of users, wherein each member of the subset has a social relationship with at least one of the connected social contacts; and
sending a content distribution request to each member of the subset, the content distribution request identifying an action that results in distribution of a message intended for the target community.

9. The computer-implemented method of claim 8, further comprising:
receiving a confirmation for the content distribution request, the confirmation representing an authorization to distribute the message on behalf of a user; and
in response to receiving the confirmation, performing an action to distribute the message using a social handle of the user.

10. The computer-implemented method of claim 9, wherein performing the action comprises posting the message on a social networking site.

11. The computer-implemented method of claim 9, wherein performing the action comprises sending a Short Message Service (SMS) item that conveys the message.

12. The computer-implemented method of claim 8, wherein:
the message comprises a link to an online resource; and
the method further comprises analyzing traffic associated with user interaction with the link to the online resource.

13. The computer-implemented method of claim 8, further comprising:
collecting data associated with participation in the content distribution request by members of the subset.

14. The computer-implemented method of claim 13, further comprising:
generating participation statistics from the collected data; and
providing the participation statistics to the subset of the group of users.

15. A tangible and non-transitory computer readable medium having computer-executable instructions stored thereon that, when executed by a processor, perform a method comprising:
sending a request to a user, the request identifying an action related to a social media account of the user;
receiving a confirmation for the request sent to the user, the confirmation representing an authorization to take the action on behalf of the user; and
in response to receiving the confirmation, using authentication information of the user to perform the action using a social handle of the user.

16. The computer readable medium of claim 15, wherein:
the request comprises a message intended for publication; and
the action comprises posting the message on a social networking site.

17. The computer readable medium of claim 15, wherein:
the request comprises a message intended for publication; and
the action comprises sending a Short Message Service (SMS) item that conveys the message.

18. The computer readable medium of claim 15, wherein:
the request identifies previously published content; and
the action comprises re-publishing the previously published content.

19. The computer readable medium of claim 15, wherein:
the request identifies a target; and
the action comprises creating a social connection between the user and the target.

20. The computer readable medium of claim 1, wherein:
the request comprises a message intended for publication;
the message comprises a link to an online resource;
the action comprises publishing the message; and
the method further comprises analyzing traffic associated with user interaction with the link to the online resource.
